(19) United States
(12) Patent Application Publication
(10) Pub. No.: US 2026/0219216 A1
(43) Pub. Date: Jul. 30, 2026

(54) ALKALINE EARTH OXIDE OR CARBONATE CONTAINING PARTICLE ANALYSIS USING MULTI-ENERGY X-RAY DETECTION

(71) Applicant: Carmeuse Technologies SA, Louvain-la-Neuve (BE)

(72) Inventor: Alex AUBERT, Ganshoren (BE)

(21) Appl. No.: 19/145,860

(22) PCT Filed: Dec. 22, 2023
(86) PCT No.: PCT/EP2023/087662

§ 371 Date: Jul. 3, 2025

(30) Foreign Application Priority Data
Jan. 3, 2023 (EP) 23150216.2

(51) Int. Cl. G01N 23/087; C01F 11/06; F27B 17/02; G01N 15/00; G01N 15/02

(52) U.S. Cl. CPC G01N 23/087; C01F 11/06; F27B 17/02; G01N 15/02; G01N 2015/0019; G01N 2015/0288

(57) ABSTRACT

The present disclosure relates to a method for monitoring at least one physico-chemical parameter of particle(s), in particular pebble(s), the composition of the particle(s) being quicklime or limestone. The method may include irradiating the particle(s) with at least one X-Ray source, and collecting radiation passing through the particle(s) in at least one X-ray detector. The detector has at least one detection area to detect one or more energy bins. The method includes measuring the intensities or fluxes of the collected radiation for each detection area and energy bin, determining at least one value from the measured intensities or fluxes for each energy bin and for each detection area, and determining the at least one physico-chemical parameter of the particle(s) as a function of the at least one value obtained for each energy bin and for each detection area.

### TECHNICAL FIELD

The present disclosure relates to a method for monitoring at least one physico-chemical parameter of particle(s), being selected from the group consisting of quicklime or limestone and a system for monitoring the at least one physico-chemical parameter of said particle(s), as well as a kiln comprising said system.

### BACKGROUND ART

The physico-chemical analysis of (dolomitic) quicklime particles, in particular pebbles is critical for the production optimization and supply quality in the lime industry. However, such analysis appears to be challenging. Typically a quicklime particle comprises a core in which a large fraction of CaCO₃ is present, the core being inside a CaO matrix with substantially no traces of CaCO₃. This structure is principally common for large particles. This material segregation/gradient is due to thermal and mass transfer mechanism taking place during the calcination. Alternatively, the CaCO₃ fraction can be randomly situated due to particles breakage during production process and surface recarbonatation. The content of unburnt material (CaCO₃) is one of the major quality indicators in the lime industry.

Indeed, a common customer specification for a quicklime production is an average content of CO₂<2%. The content CO₂ represents the amount of CO₂ released from the quicklime for instance during a thermal gravimetric analysis (TGA). The CO₂ stems from residual carbonate present in the quicklime. An average CO₂ content of 2% in weight corresponds to an average CaCO₃ content of 4.5% in weight assuming that the carbonate materials are in the form of CaCO₃. Therefore, the use of CO₂ content is an alternative way to describe the CaCO₃ content (under certain hypothesis as mentioned above), and vice versa, as there are proportional to one another. Any CO₂ content below customer's specification is an increase in energy consumption and thus production cost. Therefore, there is a need to control precisely the CO₂ (or CaCO₃ equivalent) content as close as possible to the maximum of CO₂ (or CaCO₃ equivalent) limit.

Typically, such analysis can be either a destructive analysis or an non-destructive testing solution. The former approach generally encompasses the following steps: first sampling a small quantity of the quicklime to be characterized, then processing said sample to be suitable for analysis (crushed/split/pulverized etc.), subsequently analyzing said sample in a laboratory by different analytical methods such as Loss On Ignition, XRF, C/S analysis and Titration. At the end of the process, a set of chemical composition for the quicklime sample is constituted. This sample is expected to be representative of the product overall quality. Even if such method allows to determine accurately an average composition of a quicklime particle or a group of quicklime particles, it has the drawbacks that it is time consuming and the sample size is small leading to a poor representativity.

In other industries than the lime sector, non-destructive testing solution have been proposed to streamline the operations such as X-ray Fluorescence (XRF), laser Induced Breakdown Spectroscopy (LIBS) and Near InfraRed (NIR). These three methods are however not suitable for the lime industry as they are used as surface method. Indeed, they are not suitable for investigating the composition inside the quicklime particles such as the amount of the residual carbonates, such as CaCO₃ that are generally concentrated inside the particles. Equally, a common non-destructive method allowing internal investigation of particles in general, namely the Prompt Gamma Neutron Activation (PGNA) is unable to characterize low atomic number elements such as oxygen or carbon, that are found in alkaline earth carbonate and/or alkaline earth oxide based compositions which are typically encountered in the lime industry.

Another non-destructive method allowing internal investigation of particles is disclosed in AU199510054 A1. This method relies on the classification of particles according to their internal composition using X-radiations, at respective first and second energy levels (Dual X-ray source). For this purpose, a first and second values representative of the attenuation of the radiation by each particle are determined. A third value is then derived as the difference between or ratio of the first and second values, and the particles are classified according to whether the third value is indicative of the presence in the particles of a particular substance. An industrial application of this method relates to the classifying of diamondiferous kimberlite into a fraction consisting of kimberlite particles containing diamond inclusions and a fraction consisting of barren kimberlite particles. U.S. Pat. No. 8,742,277B2 discloses a method for separating mineral impurities from calcium carbonate-containing rocks by comminuting the calcium carbonate-containing rocks by means of a dual energy X-ray transmission sorting device. However, the teaching of this disclosure cannot be transposed to the field of lime as discussed in the detail description of the present disclosure.

### SUMMARY

The present disclosure aims to provide a solution to overcome at least one drawback of the teaching provided by the prior art.

In particular the present disclosure aims to provide a non-destructive method adapted to quantify the overall residual amount of carbonate in quicklime particles.

For the above purpose, the present disclosure is directed to a method for monitoring at least one physico-chemical parameter of particle(s), in particular pebble(s), the composition of said particle(s) being selected from the group consisting of quicklime, limestone, hydrated lime or recarbonated lime, said method comprising the steps of: irradiating the particle(s) with at least one X-Ray source, collecting radiations passing through the particle(s) in at least one X-ray detector, said detector comprising at least one detection area, in particular pixel areas, said area being adapted to detect one or more energy bins, wherein each energy bin comprises a range of energy levels, measuring the intensities or fluxes of the collected radiations for each energy bin and for each detection area; determining at least one value from the measured intensities or fluxes for each energy bin and for each detection area; determining the at least one physico-chemical parameter of the particle(s) as a function of the at least one value obtained for each energy bin and for each detection area.

According to specific embodiments of the present disclosure, the method for monitoring at least one physico-chemical parameter of particle(s) comprises one or more of the following steps:
the at least one physico-chemical parameter is selected from the group consisting of: chemical composition, in particular presence of one or more foreign components, density, particle size distribution, purity, the presence of an uncalcinated core, the mass of an uncalcinated core and porosity;
the step of determining of the at least one physico-chemical parameter or the chemical composition comprises determining the CaO content and CaCO₃ content;
the step of determining of the chemical composition comprises determining at least one of CaO content, MgO content, CaCO₃ content and/or MgCO₃ content;
the step of determining of the at least one physico-chemical parameter or the chemical composition comprises determining at least one of CaO content, MgO content, Ca(OH) 2 content, Mg(OH) 2 content CaCO₃ content and/or MgCO₃ content;
the step of determining of the at least one physico-chemical parameter or the chemical composition comprises determining the Ca(OH) 2 content and CaCO₃ content;
recording photon counts arriving at the at least one detection area and optionally sorting each count into the more energy bins of each detection area;
the at least one physico-chemical parameter comprises one or more distributions of the areal density of one or more chemical compounds of the particle(s) as a function of X and Y coordinates, preferably the one or more chemical compounds comprising at least one of CaO, MgO, CaCO₃ and/or MgCO₃;
conveying the particle(s) on a conveyor belt to an irradiation zone;
the number of energy bins is greater than or equal to three, preferably greater than or equal to four, more preferably greater than or equal to eight, for instance greater than or equal to sixteen, in particular greater than or equal to thirty-two, notably greater than or equal to sixty-four.

The present disclosure is also related to a method for controlling the quality of particle(s), in particular pebble(s) comprising performing at regular time intervals the steps of the method for monitoring at least one physico-chemical parameter of particle(s).

The present disclosure is also related to a method for validating a batch of particles by performing the steps of the method for monitoring at least one physico-chemical parameter of the particles over at least a length or mass portion said batch.

The present disclosure is also related to a method for sorting particle(s) as a function of the at least one physico-chemical parameter, in particular at least one of CaO content, MgO content, CaCO₃ content and/or MgCO₃ content, determined in the method for monitoring at least one physico-chemical parameter of particle(s).

The present disclosure is also related to a system for monitoring at least one physico-chemical parameter of particle(s), in particular pebble(s), the composition of said particle(s) being selected from the group consisting of quicklime, limestone, hydrated lime or recarbonated lime said system being adapted to carry out the steps of the method for monitoring at least one physico-chemical parameter of particle(s), said system comprising: optionally a conveying means, in particular a conveyor belt for transporting said particle(s); at least one source of X-rays; at least one detector of X-rays comprising at least one detection area, in particular pixel areas and said area being adapted to detect one or more energy bins, wherein each energy bin comprises a range of energy levels; and a computation unit for processing the measured intensities or fluxes of the collected radiations for each energy bin and for each detection area and for deriving therefrom the at least one physico-chemical parameter of the particle(s).

The present disclosure is also related to a kiln for decarbonating carbonate minerals such as limestone or recarbonated lime, said kiln such as a rotary kiln or a parallel flow regenerative kiln comprising: at least one receptacle for calcinating the carbonate minerals; at least one system for monitoring at least one physico-chemical parameter of particles(s), in particular pebble(s), produced or to be fed in the at least one receptacle, optionally said kiln comprising at least one conveyor connecting the at least one receptacle to the at least one system for monitoring at least one physico-chemical parameter of said particles(s), preferably said system being within a radius of 3 km, preferably 1 km, in particular 500 m from said kiln.

The measures of the present disclosure are advantageous because they allow a non-destructive analysis inside the quicklime particles contrary to surface analysis methods, such as NIR/LIBS/XRF. Moreover, they are preferred compared to the destructive analysis approaches because they allow to analyse a large sample amount of particles increasing the statical significances of the measures performed. Even the entire production particle stream could be continuously monitored. Furthermore, they allow real time measurement resulting in an improved control of the quicklime production, so that corrective measures can be rapidly implemented when, for instance, the production quality deviates from the target. Additionally, the measures of the present disclosure allow to perform a real time sorting of quicklime based on the quality (of batch or individual particles).

Another aspect of the present disclosure relates to a parallel flow regenerative kiln for decarbonating carbonate materials, in particular limestone, comprising:
a first and a second shaft assembly, and optionally a third shaft assembly with preheating, combustion and cooling zones;
a cross-over channel between each shaft assembly,
   wherein at least one, in particular each of the shaft assemblies comprises:
a discharge mechanism positioned at the bottom of the cooling zone of the at least one of the shaft assemblies;
a collecting hopper connected to the discharge mechanism;
   wherein the at least one, in particular each of the shaft assemblies comprises openings, each opening ensuring counter current transfers of:
a cooling gas supplied by a cooling gas supply system to the cooling zone of said shaft assembly and
decarbonated materials from the cooling zone of said shaft assembly into the collecting hopper;
   wherein the discharge mechanism is configured to discharge the decarbonated materials from the cooling zone of said shaft assembly into the collecting hopper via at least one of the openings;
   wherein the collecting hopper comprises at least two chambers comprising a first chamber with at least one outlet for discharging the decarbonated materials and a second chamber with at least one outlet discharging the decarbonated materials;
   wherein the collecting hopper comprises at least one movable guiding element positioned:
underneath the at least one of the openings, and
above:
   at least one inlet of the first chamber, said inlet being adapted for collecting the decarbonated materials discharged from the at least one of the openings and
   at least one inlet of the second chamber, said inlet being adapted for collecting the decarbonated materials discharged from the at least one of the openings;
      wherein the at least one guiding element is configured to guide the decarbonated materials discharged from the at least one of the openings to either one, the other one or both of the first and the second chamber.

According to specific embodiments, the parallel flow regenerative kiln comprises one or more of the following features:
the at least one of the openings comprises a first opening and a second opening, wherein the at least one inlet of the second chamber comprises at least two inlets, wherein said kiln is configured so that:
   depending on a control position of a first of the at least one guiding element, the first opening is adapted to discharge the decarbonated materials in either the least one inlet of the first chamber or one of the at least two inlets of the second chamber, or optionally a combination of both, and/or
   depending on a control position of a second of the at least one guiding element, the second opening is adapted to discharge the decarbonated materials in either the at least one inlet of the first chamber or another of the at least two inlets of the second chamber, or optionally a combination of both;
the at least one inlet of the first chamber is interposed between the one and the other one of the at least two inlets of the second chamber;
the at least one inlet of the first chamber, the one and the other one of the at least two inlets of the second chamber are disposed along a horizontal axis;
the first and the second chamber comprise at least one common wall dividing the collecting hopper;
the at least one common wall comprises a first common wall whose upper portion is interposed between the one of the at least two inlets of the second chamber and the at least one inlet of the first chamber and a second common wall whose upper portion is interposed between the at least one inlet of the first chamber and the other one of the at least two inlets of the second chamber;
the at least one outlet of the first and the second chamber are disposed along a longitudinal axis orthogonal to the horizontal axis;
the first chamber has an inverted truncated funnel shape, wherein the at least one inlet of the first chamber defines the larger base of said truncated funnel shape and wherein the lower base of said truncated funnel shape defines the at least one outlet of the first chamber;
the second chamber has a V shape, wherein the one and the other one of the at least two inlets of the second chamber are formed at the upper tips of the V and the at least one outlet of the second chamber is formed at the base of the V shape;
the first of the at least one guiding element is positioned between the one of the at least two inlets of the second chamber and the at least one inlet of the first chamber and the second of the at least one guiding element is interposed between the at least one inlet of the first chamber and the other one of the at least two inlets of the second chamber;
each of the at least one guiding element consists in or comprises a flap, preferably a pivotable flap;
the mechanism comprises a discharge table mechanism configured to swing along a transversal axis;
the transversal axis is the horizontal axis;
the discharge table mechanism extends transversally from a first tip end to a second tip end, wherein the first opening is delimited by the first tip end of said table mechanism and a first gantry member of the at least one of the shaft assemblies, said first gantry member being adjacent to the first tip end, and the second opening is delimited by the second tip end of said table mechanism and a second gantry member of said shaft assembly, said second gantry member being adjacent to said second tip end;
the discharge table mechanism comprises a central aperture positioned in a middle portion of said table mechanism between the first tip end and the second tip end of said table mechanism, wherein the at least one of shaft assemblies comprises a discharge beam extending above the central aperture thereby forming a discharge space free of the decarbonated materials, wherein an upper surface of the discharge table mechanism and a lower portion said beam define a third opening and a fourth opening of the openings, said openings open in said discharge space though which decarbonated materials are discharged, before the decarbonated materials reach the first chamber via the central aperture.
decarbonated materials comprising quicklime, preferably at least 90% CaO and/or MgO by weight.

### BRIEF DESCRIPTION OF THE DRAWINGS

Aspects of the present disclosure will now be described in more detail with reference to the appended drawings, wherein same reference numerals illustrate same features.

FIG. 1A shows a first embodiment according to the present disclosure.

FIG. 1B shows an alternative according to the present disclosure.

FIG. 2 shows dual X-ray sources.

FIG. 3 shows a single X-ray source with detection bins.

FIGS. 4A, 4B and 4C show an individual control of a quicklime particle.

FIGS. 5A, 5B, 5C show a control of multiple quicklime and limestone particles.

FIG. 6 illustrates the definition of the areal density.

FIG. 7 shows a kiln installation according to the present disclosure.

FIG. 8 depicts a schematic view of a parallel flow regenerative kiln for decarbonating carbonate materials, according to the other aspect of the present disclosure.

FIG. 9 illustrates a schematic view of a lower end region of a shaft assembly of a parallel flow regenerative kiln according to the other aspect of the present disclosure.

FIG. 10 depicts a schematic view of a lower end region of a shaft assembly of a further parallel flow regenerative kiln according to the other aspect of the present disclosure.

FIGS. 11A, 11B and 11C show an example of a collecting hopper lower portion adapted for a parallel flow regenerative kiln according to the other aspect of the present disclosure.

FIG. 12 illustrates a schematic view of a lower end region of a shaft assembly of another parallel flow regenerative kiln according to the other aspect of the present disclosure.

### DETAILED DESCRIPTION

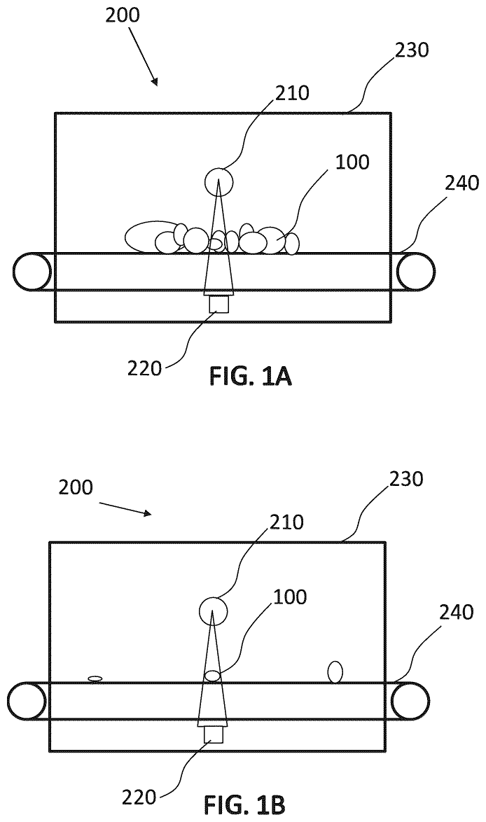

FIG. 1A shows a first embodiment according to the present disclosure. In FIG. 1A, the analysis system comprises a X-ray monitoring system 200 using a multi energy bin detector 220 to quantify the material composition and the mass of a quicklime particle batch 100. Alternatively, quicklime particles can be scanned one by one as illustrated in FIG. 1B. The use of a multi energy X-ray detector or a multi energy X-ray source allows to investigate the composition of the materials constituting a sample. Indeed, according to the Lambert-Beer's law applied to a composition comprising two materials (e.g. 1:CaO and 2:CaCO₃), the intensity I of the radiation measured depends on the areal density (density×thickness) of the respective basis materials, namely CaO and CaCO₃.

$${I}_{i = 1 , 2} = \int dI = \int {S ( E )}_{i} exp ( - {a}_{1} \cdot {μ}_{1} ( E ) - {a}_{2} \cdot {μ}_{2} ( E ) ) dE \qquad Equation 1$$

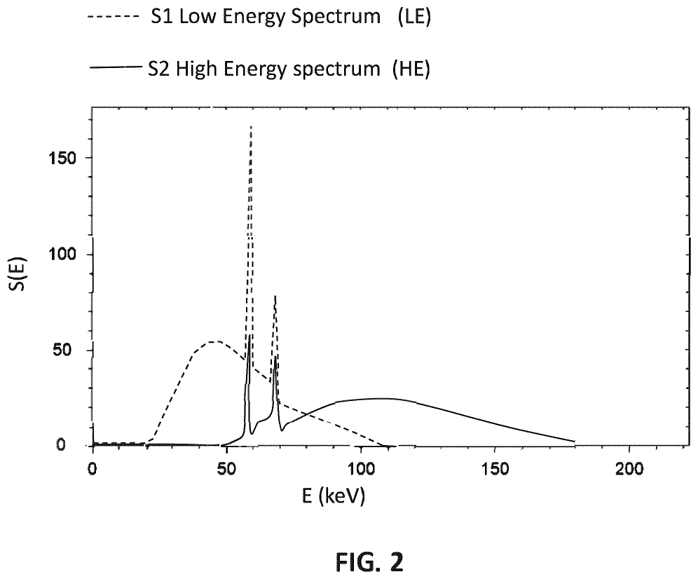

In Equation 1, μ_{i=1, 2} (E) are the attenuation coefficients of the two different basis materials. In the present approach, the material attenuation coefficients (index 1 and 2) are considered to be known and their areal densities a₁ and a₂ to be determined. This approach therefore allows to determine the areal densities of the two materials. If the heigh of the sample is provided, the densities can be determined too. To perform the determination, the exposure of the sample to two different spectra S(E) (dual X-ray sources) as illustrated in FIG. 2 results in two different intensities I_{i=1,2}. Therefore, two equations with two unknowns (a₁ and a₂) can be solved under certain condition. Alternatively, a measurement spectrum can be divided into two energy bins characterized by a given energy (wave) range. This approach of dividing a single spectrum leads a system with an equation for each energy bin, leading to two equations with two unknowns (a₁ and a₂).

The measurement spectrum or spectra can be divided into more than two energy bins. For instance, the dual-X ray source can be combined with a detector comprising at least two measurement bins. The number of incident spectra can be more than two and the number of components to be investigated can be more than two, too.

A dual energy level X-ray detection system is disclosed in AU199510054 A. However, this method is not aimed at quantifying chemical compositions of particles but rather at classifying them depending on the difference between radiation fluxes I₁, I₂ measured for two different spectra S(E)₁; S(E)₂. The particles are classified according to whether this ratio or difference value is indicative of the presence in the particles of a particular substance. This approach allows to classify efficiently diamondiferous kimberlite into a fraction consisting of kimberlite particles containing diamond inclusions and a fraction consisting of barren kimberlite particles. It should be stressed that the attenuation coefficients μ_{i=1, 2} (E) for low energy level are substantially different for diamond inclusions and barren kimberlite particles, while at high energy level they are similar. The comparison between the measured high energy and low energy spectra leads to a robust classification. This approach is not transferable to the lime industry, which aims to produce quicklime with a content range of CaCO₃ as narrow as possible around 4.5%. Moreover, for the case of calcium oxide (CaO) and calcium carbonate (CaCO₃), the attenuation coefficient μ_{i=1, 2} (E) are comparable over a large energy range rendering the detection difficult because the differentiation of comparable low atomic number atoms, such as Oxygen (Z=8) and Carbon (Z=6) is difficult.

Using a large number of energy detection bins such N bins and optionally multi X-ray source such as dual spectra source lead to improved determination using techniques for determining the areal densities a₁ and a₂, and optionally more aj. By spreading the calculation on several energy bins of the X-ray detector it is possible to differentiate CaO and CaCO₃ molecules even though they have similar absorption, knowing that each of the CaO and CaCO₃ molecules has a same heavy atom, namely calcium (Z=20).

In particular, in an example, the X-ray detector has 64 energy bins for the measurement. The energy bins correspond to a detection range of ~2.2 keV. The first bin covers the [20; 22.2] keV energy band. The last bin covers the [157.8; 160] keV band. Furthermore, the parameters used comprise acceleration voltage of 225 kVp, an anode of Tungsten, a filtration with Beryllium with 2 mm thickness and Aluminum with 11 mm thickness, and incident full flux 15 MPhotons/pix/s.

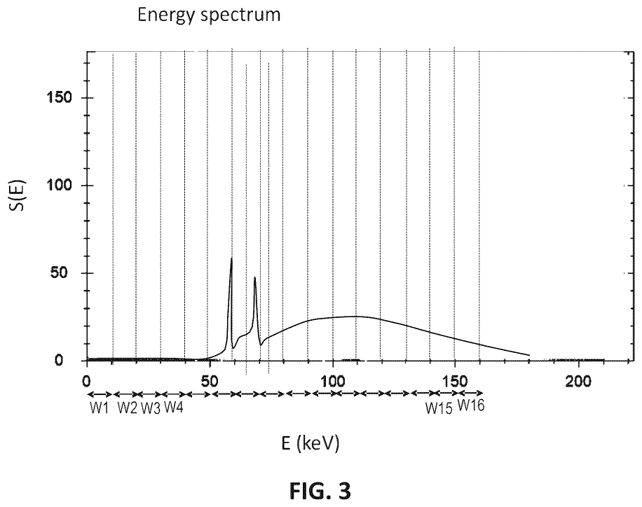

The spectrum used as source to irradiate a sample can be based on the one presented in FIG. 3.

The attenuation coefficients μ_{i=1, 2} (E) can be determined through calibration with reference standards or empirical data. The attenuation coefficients μ_{i=1, 2} (E) are then fed in a model based on Equation 1. Using intensities Iᵢ measured on a given sample, one can determine of the areal densities aᵢ of this sample through the solving of the model.

Alternatively, machine learning based approaches can be applied such as neural network. In this case a model predicting the areal densities of at least CaO and CaCO₃ is parametrized with several reference samples with thicknesses ranging from 1 to 12 cm for instance, with various CaO/CaCO₃ concentrations.

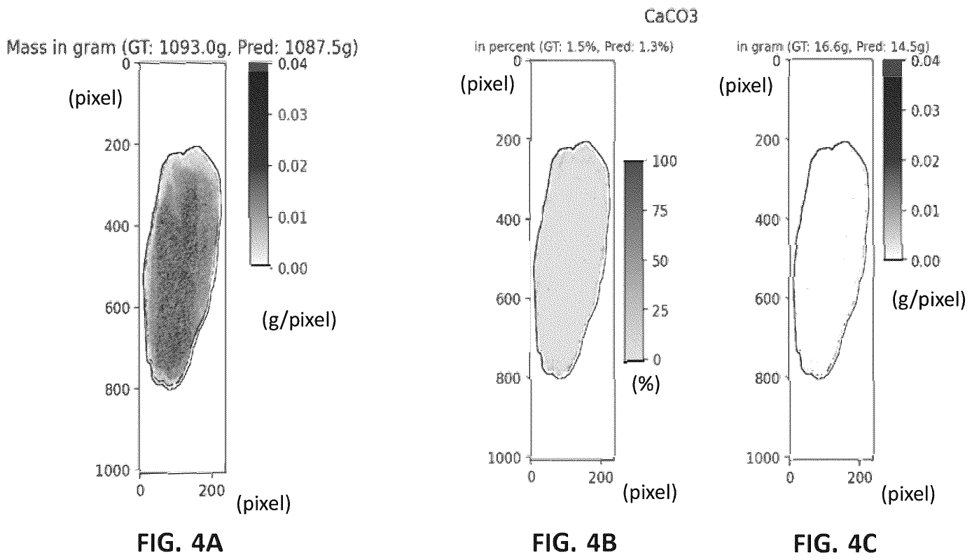

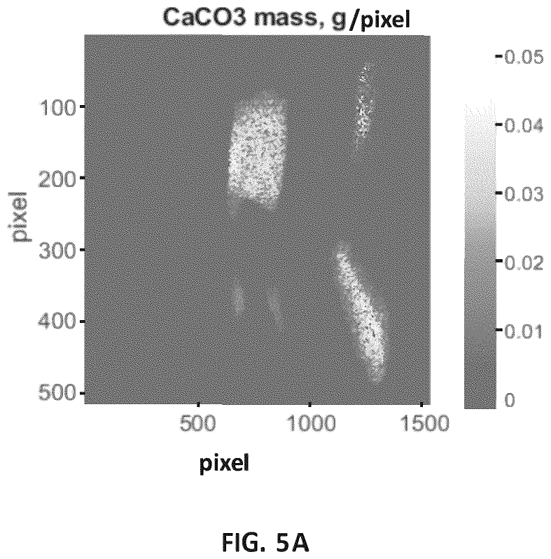

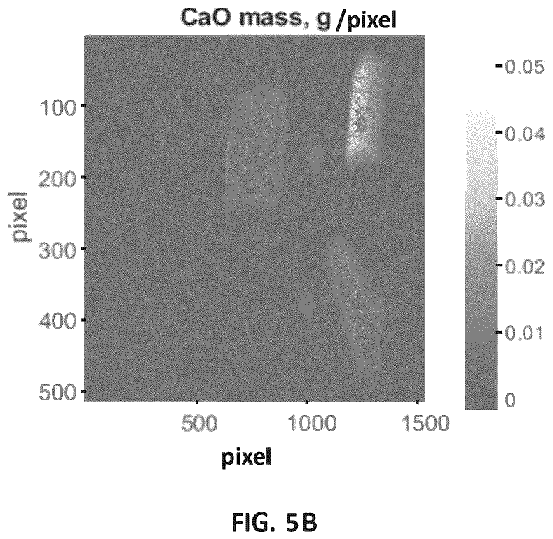

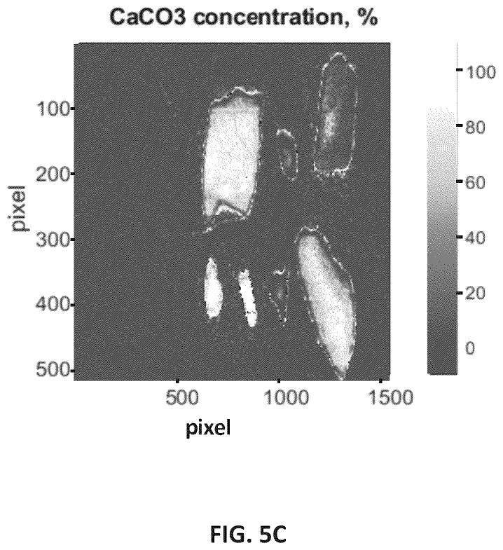

Multi energy X-ray detector 220 typically relies on photon-counting (energy-resolving) x-ray detector and signal-processing components. The semiconductor detector (eg, CdTe) directly converts the absorbed X-ray energy into electrical charge, which is accelerated across a potential difference and collected by discreet signal electrode. The signals collected are binned according to energy level as the signals are proportional to the absorbed photon energy levels. The pulse height is used to discriminate the photons. This analysis is used to bin the signals from discreet photon interactions into two or more energy windows. The number of energy windows can be selected depending on the needs to obtain an effective composition analysis. Furthermore, the X-ray detector can be pixelized so that the incident radiation intensities can be mapped according to x and y coordinates, as illustrated in FIGS. 4A, 4B, 4C, 5A, 5B and 5C. The X-ray detector may have multiple pixel areas, each pixel area forming a detection area, each pixel area comprising one or more pixels. The X-ray detector may comprises a multilayer detector.

As illustrated in FIG. 1A, a quicklime particle batch 100 extracted form a kiln is transported on a conveyor belt 240 to an irradiation zone 200, namely the system for monitoring at least one physico-chemical parameter of an particle batch. The system 200 comprises an X-ray source 210 and an X-ray detector 220 provided with a radiation shield 230. Thanks to these measures, it is possible to control large samples thereby improving the quality control. The control can be performed at regular time intervals. The control can be performed on a length/mass portion or the entire particle batch. The detector 220 allows to obtain the areal density distributions of the chemical components of the particle batch.

Individual control of quicklime particle is illustrated in FIGS. 4A, 4B and 4C. FIG. 4A shows a 2D distribution of the areal density of the particle. A black line is added by the display interface to delimit the outer contour of the pebble. In FIGS. 4B and 4C, the weight faction distribution of CaCO₃ as well as the areal density of the CaCO₃ are shown. It could be observed a substantially uniform low concentration of CaCO₃ across the particle. This particle does not show a typical CaCO₃ core within a CaO matrix. This particle, pebble produced in a parallel regenerative kiln can be sorted for application requited a high level of CaO purity.

FIGS. 5A, 5B and 5C show 2D composition distributions of 7 pebbles (3 quicklime pebbles and 4 limestone pebbles). FIG. 5A shows areal density of CaCO₃, FIG. 5B shows areal density of CaO. FIG. 5C shows the CaCO₃ weight fraction. The 3 lime pebbles, in particular the one in the top right corner of the picture shows a typical CaCO₃ core within a CaO matrix

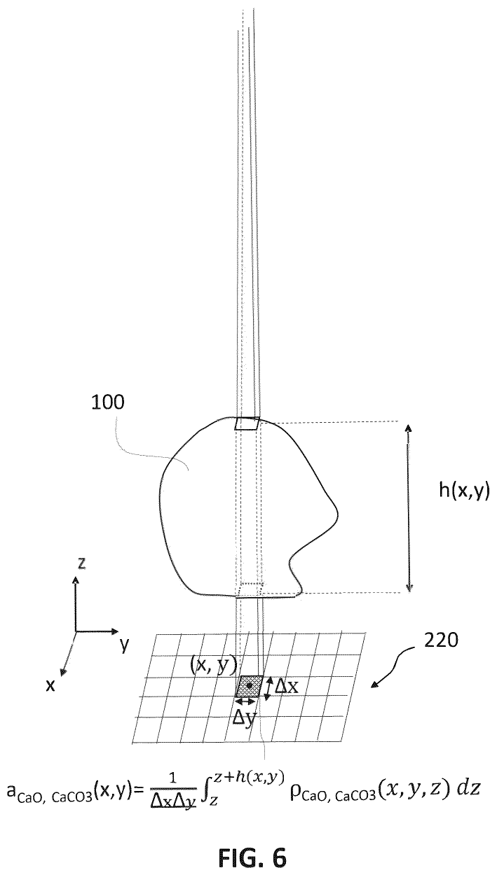

As illustrated in FIG. 6, the areal density for each constituent of a quicklime particle, namely CaCO₃ and CaO represents the weight of vertical borehole divided by its sectional area. With modern display technique the areal density is expressed in g/pixel and sometime directly in g as a pixel is a dimensional unit. By comparing the weight of a component such as CaCO₃ to the weight of all components (CaCO₃+CaCO), it is possible to obtained the distribution of the weight fraction of this component, assuming that there are two constituents as show in equation 2:

$$Weight {fraction}_{CaCO 3} ( x , y ) ( \% ) = \frac{{a ( x , y )}_{CaCO 3}}{a ( x , y )} = \frac{{a ( x , y )}_{CaCO 3}}{{a ( x , y )}_{CaCO 3} + {a ( x , y )}_{CaO}} \qquad Equation 2$$

The mass faction of CaCO₃ (m_{CaCO3}) of a particle can be determined with the following formulas:

$${m}_{CaCO 3} = {\int }_{Particle / Pebble contour} {a ( x , y )}_{CaCO 3} dXdY \qquad Equation 3$$

$${m}_{pebble} = {m}_{CaCO 3} + {m}_{CaO} = {\int }_{Par . / Peb . cont .} {a ( x , y )}_{CaCO 3} + {a ( x , y )}_{C a O} dXdY \qquad Equation 4$$

$$Overall Weight fraction of {CaCO}_{3} = \frac{{m ( x , y )}_{CaCO 3}}{{m}_{pebble}} \qquad Equation 5$$

This approach can be generalized to a particle batch where the contour can correspond to the frame of the radiation window.

The areal density; masses and fractions are given for two constituents, namely CaCO₃ and CaO. Other component such as MgO, MgCO₃, and traces of dolomitic limestone such as (CaCaO₃)ₓ·(MgCO₃) y and certain impurities can be integrated into the model, providing that further calibrations are performed. The analysis of magnesium containing materials is advantageous, in particular for dolomitic quicklime or burnt dolime.

Even if the examples are related to quicklime (CaO) and dolomitic lime ((CaO)ₓ·(MgO)_{y}), the measures of the present disclosure can generalized to calcium and/or magnesium carbonate based materials such as limestone, in particular dolomitic limestone, preferably dolomite to quantify their purity before they are fed to a kiln.

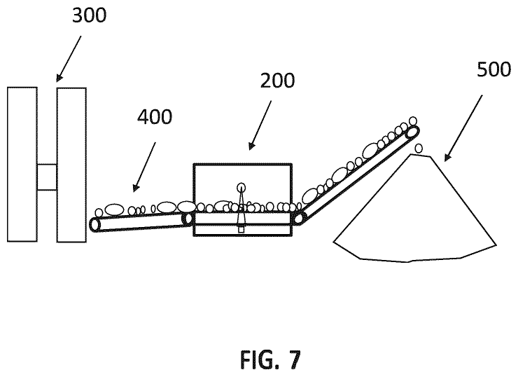

Advantageously, the detection installation 200 is preferably close to one or more kilns 300 where the limestone is calcinated to produce quicklime particles as illustrated in FIG. 7 for one kiln. The quicklime particles are transported on conveyor band(s) 400 to storage location(s) 500. The X-ray detection system(s) 200 can be positioned on one or more conveyor belts so that the calcinated materials, namely the quicklime particles 100 can be monitored continuously or at regular time intervals. A X-ray detection system(s) 200 can be associated permanently to a given conveyor belt or be portable to the extent that it can be moved from one conveyer belt to another one depending on the needs.

Particles to be analyzed with the measures of the present disclosure can have particle size, in particular a d90 less than 150 mm, preferably less than 120 mm for kilns with quasi steady material moving bed (e.g. Parallel flow regenerative kiln or rotary kilns). Typically, the particles processed in parallel flow regenerative kiln or rotary kilns are called pebbles. Equally, “small” particles conveyed by a fluid though a pipe can be analyzed advantageously. In this case, the conveying pipe can be advantageously interposed between the X-ray source and the X-ray detector. “Small” particles may have d90 less than 6 mm, more preferably less than 4 mm.

By Limestone is meant a naturally occurring mineral that consists principally of calcium carbonate. Part of the calcium carbonate may have been converted to dolomite by replacement with magnesium carbonate as a secondary component (up to 46% by weight). Many limestones are remarkably pure with less than 5% of non-carbonate impurities. By quicklime is meant a product produced by the thermal dissociation of limestone. These definitions are based on the reference book in the field of lime: Lime and Limestone, Chemistry and Technology, Production and Uses, J.A.H. Oates, WILEY-VCH ISBN 3-527-29527-5.

In the present disclosure, the term limestone should be understood as encompassing dolomitic limestone or dolomite. Equally, the term quicklime should be understood as encompassing dolomitic quicklime and burnt dolime.

By burnt dolime or dolomite is meant a dolomitic quicklime or dolomitic limestone composition respectively, in which the amount of Mg in moles is substantially equal to the amount in moles of Ca.

By recarbonated lime is meant as mineral that consist essentially of calcium carbonate obtained by recarbonation of quicklime or hydrated lime in CO₂ containing gas such as air or flue gases.

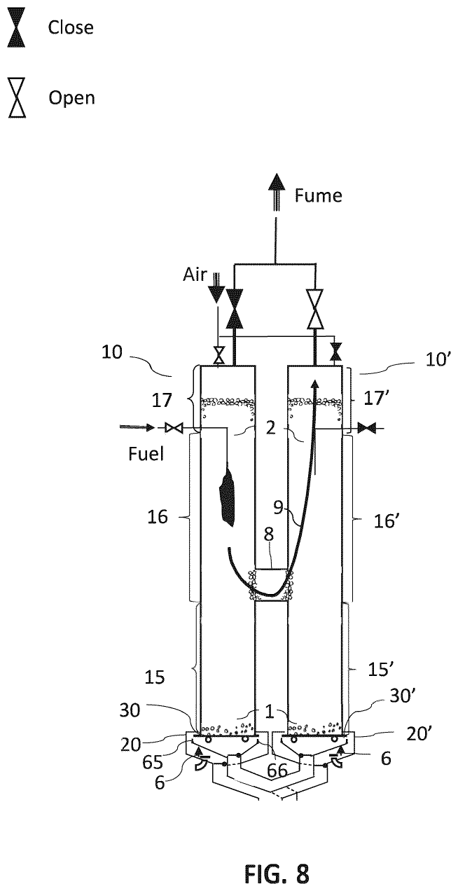

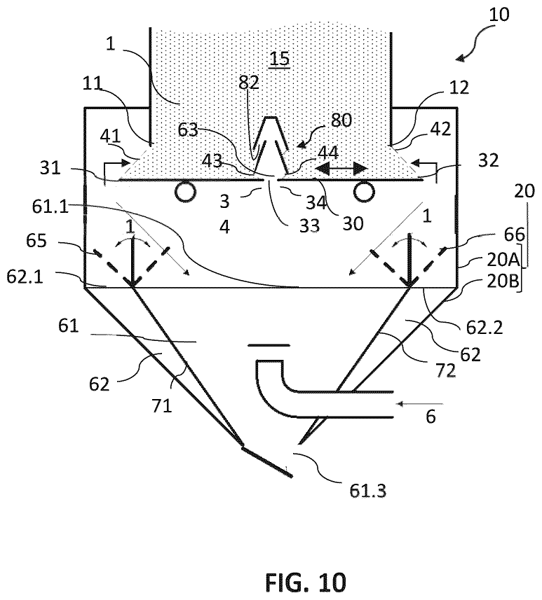

FIG. 10 depicts a schematic view of a parallel flow regenerative kiln for decarbonating carbonate materials, in particular limestone, comprising a first 10 and a second 10′ shaft assembly with preheating 17, 17′, combustion 16, 16′ and cooling zones 15, 15′, a cross-over channel 8 between the first 10 and the second 10′ shaft assembly. Each of the shaft assemblies 10, 10′ comprises a discharge mechanism 30, 30′ positioned at the bottom of the cooling zone 15, 15′, a collecting hopper 20, 20′ connected to the discharge mechanism 30. The parallel flow regenerative kiln illustrated in FIG. 8 can be the kiln 300 illustrated in FIG. 7.

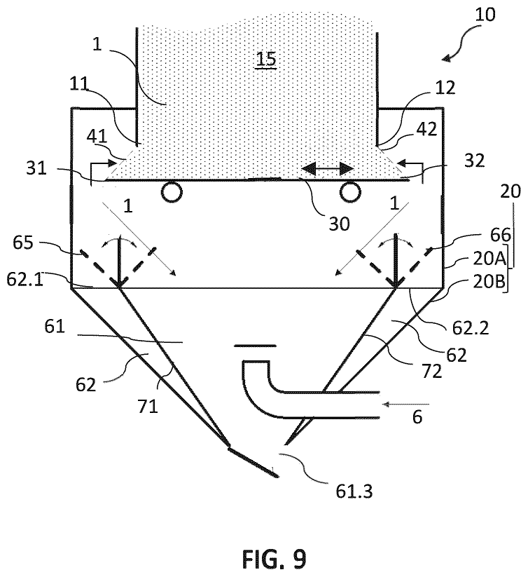

FIG. 9 illustrates a schematic view of a lower end region of a shaft assembly. The shaft assembly 10 comprises openings 41, 42, wherein each opening 41, 42 ensures counter current transfers of: a cooling gas 6 supplied by a cooling gas supply system to the cooling zone 15 and decarbonated materials 1 from the cooling zone 15 into the collecting hopper 20.

The discharge mechanism 30 is configured to discharge the decarbonated materials 1 from the cooling zone 15 into the collecting hopper 20 via the openings 41, 42. The discharge table mechanism 30 extends transversally from a first tip end 31 to a second tip end 32, wherein the first opening 41 is delimited by the first tip end 31 of said table mechanism 30 and a first gantry member 11 adjacent to the first tip end 31. Likewise, the second opening 42 is delimited by the second tip end 32 of said table mechanism 30 and a second gantry member 12 adjacent to said second tip end 32.

The collecting hopper 20 comprises a first chamber 61 with an outlet 61.3 for discharging the decarbonated materials 1 and a second chamber 62 with an outlet (not illustrated) for discharging the decarbonated materials 1. The collecting hopper 20 comprises an upper portion 20A and a lower portion 20B. The collecting hopper 20 has two movable guiding element 65, 66 positioned respectively underneath the the openings 41, 42 and above an inlet 61.1 of the first 61 chamber, said inlet being adapted for collecting the decarbonated materials 1 discharged from the openings 41, 42. The collecting hopper 20 is also configured such as two inlets 62.1, 62.2 of the second 62 chamber are adapted for collecting the decarbonated materials 1 discharged from the openings 41, 42. The inlet 61.1 of the first chamber 61 is interposed between the first inlet 62.1 of the second chamber 60 and the second inlet 62.2 of the second chamber 62. The first 61 and the second 62 chambers comprise two common walls 71, 72 dividing the collecting hopper 20. The upper portion of the first common wall 71 is interposed between the first 62.1 inlet of the second chamber 62 and the inlet 61.1 of the first chamber 61. The upper portion of the second common wall 72 is interposed between the inlet 61.1 of the first chamber 61 and the second inlet 62.2 of the second chamber 62. The first guiding element 65, namely a first pivotable flap, is positioned between the first inlet 62.1 of the second chamber 62 and the inlet 61.1 of the first chamber 61. The second guiding element 66, namely a second pivotable flap, is interposed between the inlet 61.1 of the first chamber 61 the second inlet 62.2 of the second chamber 62. Each flap 65, 66 can be actuated mechanically, electrically, pneumatically or hydraulically. Their angular position being selected by a user or an electronic computing unit.

The first and second guiding elements 65, 66 are configured to guide the decarbonated materials 1 discharged from the openings 41, 42 to either the first 61, the second 62 or both 61, 62 of chambers. In operation, the kiln is configured so that:
depending on a control position of the first guiding element 65, the first 41 opening is adapted to discharge the decarbonated materials 1 in either the inlet 61.1 of the first 61 chamber, the first inlet 62.1 of the second chamber 62 or a combination of both, and/or
depending on a control position of the second guiding element 66, the second 42 opening is adapted to discharge the decarbonated materials 1 in either the inlet 61.1 of the first 61 chamber, the second 62.2 inlet of the second chamber 62, or a combination of both.

FIG. 10 illustrates a schematic view of a lower end region of a further shaft assembly 10 that differs from the shaft assembly according to FIG. 9 in that the discharge table mechanism 30 comprises a central aperture 33 positioned in a middle portion of said table mechanism 30 between the first tip end 31 and the second tip end 32 of said table mechanism 30. Said assembly 10 comprises a discharge beam 80 extending above the central aperture 33 thereby forming a discharge space 63 free of the decarbonated materials 1, wherein an upper surface of the discharge table mechanism 30 and a lower portion said beam 80 define a third opening 43 and a fourth opening 44 that open in the discharge space 63 though which decarbonated materials 1 are discharged, before the decarbonated materials 1 reach the first 61 chamber via the central aperture 33. The discharge beam 80 defines further air cooling passages 82.

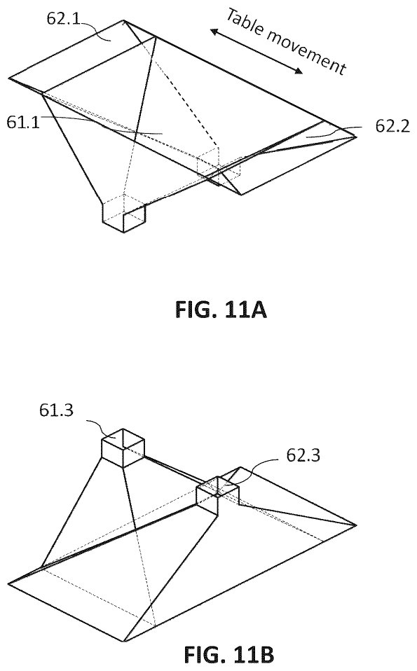

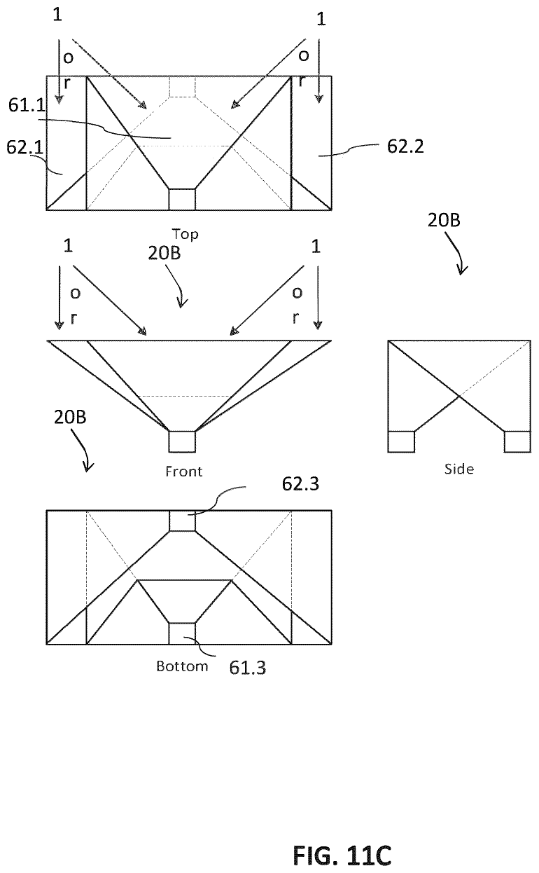

FIGS. 11A, 11B and 11C represent an example of a collecting hopper lower portion adapted for any of the shaft assemblies 10 illustrated in FIG. 9 or 10. In FIGS. 11A and 11B are shown the relative positions of the inlet 61.1 of the first chamber 61 and the first 61.1 and second 61.2 inlet of the second chamber 62, as well as the outlet 61.3 of the first chamber 61 and the outlet 61.3 of the second chamber 62. The first chamber 61 has an inverted truncated funnel shape, wherein the inlet 61.1 of the first chamber 61 defines the larger base of the truncated funnel shape and wherein the lower base of the truncated funnel shape defines the outlet 61.3. The second chamber 62 has a V shape, wherein the first 62.1 and the second 62.2 inlets of the second chamber 62 are formed at the upper tips of the V and the outlet 62.3 of the second chamber 62 is formed at the base of the V shape. The outlets 61.3, 62.3 of the first 61 and the second 62 chambers are disposed along a longitudinal axis orthogonal to the displacement axis of the discharger table.

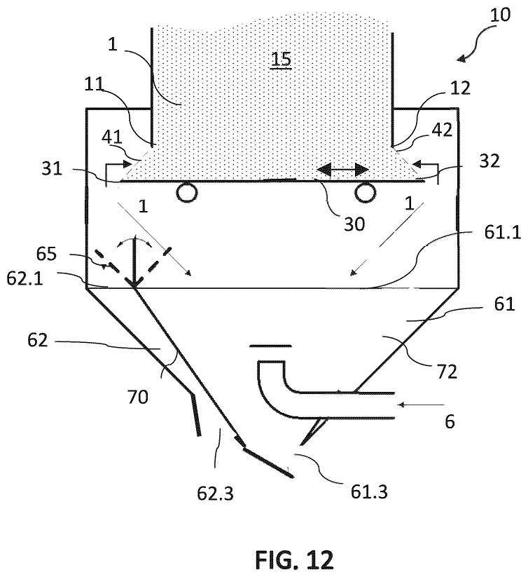

FIG. 12 illustrates a schematic view of a lower end region of another shaft assembly 10 that differs from the shaft assembly 10 according to FIG. 9 in that the second chamber comprises a single inlet 61.1 and a single common wall 70, a well as a single guiding element 65. The outlet 62.3 of the second chamber 62 is arranged laterally. This shaft assembly configuration, advantageously allows to isolate sample of decarbonated material to be investigated without disrupting the production. The sample to be investigated can be done with the measures described in the present disclosure (Method for monitoring at least one physico-chemical parameter of particle(s) and/or System for monitoring at least one physico-chemical parameter of particle(s)).

Thanks to these measure described in FIGS. 8 to 12, it is possible to overcome some drawbacks of the prior art. Indeed, it is known that lime quality (as measured by residual CO₂) can vary significantly around the cross section of the shaft of a parallel flow regenerative kiln. This can be due to problems with fuel or air distribution as well as inconsistent stone movement across the shaft. The only good way to assess this quality variation is by stopping the kiln and performing a “Table check” where lime samples are collected from the different discharge areas around the shaft and are then analyzed.

With the promise of online lime quality analyzers, such as the one disclosed in the present disclosure (Method for monitoring at least one physico-chemical parameter of particle(s) and/or System for monitoring at least one physico-chemical parameter of particle(s)), it becomes possible to detect lime residual CO₂ continuously as it is discharged from the hoppers underneath the tables onto the lime conveying belt. If the lime residual CO₂ can be continuously known, it would be beneficial to be able to segregate the lime from the different areas of the shaft in order to detect non-uniformity without requiring the stoppage of the kiln for a table check.

If an area of the shaft is detected as having quality poorer than other areas of the shaft, the ability to segregate it and it divert it to a different silo yields higher average quality for the balance of the lime from the shaft which can be sent to the premium quality silos. Segregating the poorer quality from the premium quality also reduces the occurrences of the rejection of the entire shaft's lime due to one small area of bad quality contaminating the entire shaft to the level of making it off-spec. With the ability to segregate poorer quality lime, it can be sold to less demanding markets or rejected, while producing more on-spec quality from the balance of the shaft.

Also, selectively storing the lime from different areas of the shaft allows for the possibility of producing an ultra-high-quality lime that is not currently possible due to all lime being mixed from a shaft. There could be a market advantage for this newly possible “premium quality” lime from a parallel flow regenertive kiln.

Embodiments as discussed above are defined by the following numbered clauses:
1. Method for monitoring at least one physico-chemical parameter of particle(s), in particular pebble(s) (100), the composition of said particle(s) being selected from the group consisting of quicklime or limestone, said method comprising the steps of:
a) irradiating the particle(s) (100) with at least one X-Ray source (210);
b) collecting radiations passing through the particle(s) (100) in at least one X-ray detector (200), said detector comprising at least one detection area, in particular pixel areas, said area being adapted to detect one or more energy bins, wherein each energy bin comprises a range of energy levels;
c) measuring the intensities or fluxes of the collected radiations for each energy bin and for each detection area;
d) determining at least one value from the measured intensities or fluxes for each energy bin and for each detection area;
e) determining the at least one physico-chemical parameter of the particle(s) as a function of the at least one value obtained for each energy bin and for each detection area.
2. The method according to the preceding clause, wherein the at least one physico-chemical parameter is selected from the group consisting of: chemical composition, in particular presence of one or more foreign components, density, particle size distribution, purity, the presence of an uncalcinated core, the mass of an uncalcinated core and porosity.
3. The method according to the preceding clause, wherein the step of determining the chemical composition comprises determining at least one of CaO content, MgO content, CaCO₃ content and/or MgCO₃ content.
4. The method according to any of the preceding clauses, comprising recording photon counts arriving at the at least one detection area and optionally sorting each count into the more energy bins of each detection area.
5. The method according to any of the preceding clauses, wherein the at least one physico-chemical parameter comprises one or more distributions of the areal density of one or more chemical compounds of the particle(s) as a function of X and Y coordinates, preferably the one or more chemical compounds comprising at least one of CaO, MgO, CaCO₃ and/or MgCO₃.
6. The method according to any of the preceding clauses, comprising conveying the particle(s) on a conveyor belt to an irradiation zone.
7. The method according to any of the preceding clauses, wherein the number of energy bins is greater than or equal to three, preferably greater than or equal to four, more preferably greater than or equal to eight, for instance greater than or equal to sixteen, in particular greater than or equal to thirty-two, notably greater than or equal to sixty-four.
8. Method for controlling the quality of particle(s), in particular pebble(s) comprising performing at regular time intervals the steps of any of the preceding clauses on particle(s).
9. Method for validating a batch of particles by performing the steps of any of Clauses 1 to 7 over at least a length or mass portion said batch.
10. Method for sorting particle(s), in particular pebble(s) as a function of the at least one physico-chemical parameter, in particular at least one of CaO content, MgO content, CaCO₃ content and/or MgCO₃ content, determined in the method according to any of the preceding clauses.
11. System for monitoring at least one physico-chemical parameter of particle(s), in particular pebble(s), the composition of said particle(s) being selected from the group consisting of quicklime or limestone, said system being adapted to carry out the steps of the method according to any of Clauses 1 to 7, said system comprising:
optionally a conveying means (240), in particular a conveyor belt for transporting said particle(s);
at least one source of X-rays (210);
at least one detector of X-rays (220) comprising at least one detection area, in particular pixel areas and said area being adapted to detect one or more energy bins, wherein each energy bin comprises a range of energy levels; and
a computation unit for processing the measured intensities or fluxes of the collected radiations for each energy bin and for each detection area and for deriving therefrom the at least one physico-chemical parameter of the particle(s).
12. Kiln (300) for decarbonating carbonate minerals such as limestone, said kiln such as a rotary kiln or a parallel flow regenerative kiln comprising:
at least one receptacle for calcinating the carbonate minerals;
at least one system (200) for monitoring at least one physico-chemical parameter of particles(s), in particular pebble(s) (100), produced or to be fed in the at least one receptacle, said system being a system for monitoring at least one physico-chemical parameter of particle(s) according the preceding clause.
13. The kiln (300) according to the preceding clause, comprising at least one conveyor (400) connecting the at least one kiln to the at least one system (200) for monitoring at least one physico-chemical parameter of said particles(s), preferably said system is within a radius of 3 km, preferably 1 km, in particular 500 m from said kiln (300).

While the present disclosure has been illustrated and described in detail in the drawings and foregoing description, such illustration and description are to be considered illustrative or exemplary and not restrictive. Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

The foregoing description details certain embodiments of the present disclosure. It will be appreciated, however, that no matter how detailed the foregoing appears in text, the present disclosure may be practiced in many ways, and is therefore not limited to the embodiments disclosed. It should be noted that the use of particular terminology when describing certain features or aspects of the present disclosure should not be taken to imply that the terminology is being re-defined herein to be restricted to include any specific characteristics of the features or aspects of the present disclosure with which that terminology is associated.

1. A method for monitoring at least one physico-chemical parameter of quicklime particle(s), the method comprising:
a) irradiating the particle(s) with at least one X-Ray source;
b) collecting radiation passing through the particle(s) in an X-ray detector, the detector comprising at least one detection area, in particular pixel areas, the area being adapted to detect multiple energy bins, wherein each energy bin comprises a range of energy levels;
c) measuring intensities or fluxes of the collected radiation for each energy bin and for each detection area;
d) determining at least one value from the measured intensities or fluxes for each energy bin and for each detection area;
e) determining the at least one physico-chemical parameter of the particle(s) as a function of the at least one value obtained for each energy bin and for each detection area;
f) recording photon counts arriving at the at least one detection area and sorting each count into the multiple energy bins of each detection area.

2. The method according to claim 1, wherein the at least one physico-chemical parameter is selected from the group consisting of: chemical composition, density, particle size distribution, purity, presence of an uncalcinated core, a mass of an uncalcinated core, and porosity.

3. The method according to the preceding claim 2, wherein the step of determining the chemical composition comprises determining at least one of CaO content, MgO content, CaCO₃ content, and/or MgCO₃ content.

4. The method according to claim 1, wherein the at least one physico-chemical parameter comprises one or more distributions of an areal density of one or more chemical compounds of the particle(s) as a function of X and Y coordinates.

5. The method according to claim 1, comprising conveying the particle(s) on a conveyor belt to an irradiation zone.

6. The method according to claim 1, wherein a number of the energy bins is greater than or equal to three.

7. A method for controlling quality of particle(s) comprising performing at regular time intervals the method of claim 1 on particle(s).

8. A method for validating a batch of particles, the method comprising performing the method of claim 1 over at least a length or mass portion of the batch.

9. A method for sorting particle(s), wherein the method comprises sorting the particle(s) as a function of the at least one physico-chemical parameter determined in the method of claim 1.

10. A system for monitoring at least one physico-chemical parameter of quicklime particle(s), the system being adapted to carry out the steps of the method according to claim 1, the system comprising:
at least one source of X-rays;
at least one detector of X-rays comprising at least one detection area, in the area being adapted to detect multiple energy bins, wherein each energy bin comprises a range of energy levels; and
a computation unit for processing the measured intensities or fluxes of the collected radiations for each energy bin and for each detection area and for deriving therefrom the at least one physico-chemical parameter of the particle(s).

11. A kiln for decarbonating carbonate minerals, the kiln comprising:
at least one receptacle for calcinating the carbonate minerals;
at least one system for monitoring at least one physico-chemical parameter of particles(s), in particular pebble(s), produced in the at least one receptacle, the system being a system for monitoring at least one physico-chemical parameter of particle(s) according claim 10.

12. The kiln according to claim 11, further comprising at least one conveyor connecting the kiln to the at least one system for monitoring at least one physico-chemical parameter of the particles(s).

13. The method of claim 1, wherein the detection area of the X-ray detector comprises pixel areas.

14. The method according to claim 1, wherein the at least one physico-chemical parameter comprises one or more distributions of an areal density of one or more chemical compounds of the particle(s) as a function of X and Y coordinates, wherein the one or more chemical compounds comprise at least one of CaO, MgO, CaCO₃, and/or MgCO₃.

15. The system of claim 10, further comprising a conveyor belt configured to transport the particle(s).
